(19) United States
(12) Patent Application Publication
(10) Pub. No.: US 2009/0195819 A1
(43) Pub. Date: Aug. 6, 2009

(54) Information Processing Apparatus and Program

(76) Inventors: Yasuaki Sugimoto, Tokyo (JP); Takeshi Nakajima, Tokyo (JP)

Correspondence Address: Cameron Kerrigan;Squire, Sanders & Dempsey L.L.P., One Maritime Plaza, Suite 300, San Francisco, CA, 94111, US

(21) Appl. No.: 12/359,161

(22) Filed: Jan. 23, 2009

(30) Foreign Application Priority Data
Feb. 5, 2008 (JP) JP2008-024837

(51) Int. Cl. G06F 3/12

(52) U.S. Cl. 358/1.15

(57) ABSTRACT

An image processing apparatus includes: an operation section which accepts a job setting operation; a memory section which memorizes an element of a job set through the operation section; a display section, and a controller, wherein the controller is configured to control the display section to display a plurality of jobs so as to display elements memorized in the memory section of the plurality of jobs on the display section, accept selecting elements from two or more jobs of the plurality of jobs through the operation section, and generate a new job including the elements selected.

### CROSS REFERENCE TO RELATED APPLICATION

The present application is based on Japanese Patent Application No. 2008-024837 filed with Japanese Patent Office on Feb. 5, 2008, the entire content of which is hereby incorporated by reference.

### BACKGROUND OF THE INVENTION

1. Field of the Invention

The present invention relates to an information processing apparatus and program, particularly to an information processing apparatus having a function which reflects a setting of a past job being displayed its history on setting a new job, and a program for running the information processing apparatus.

2. Background of the Invention

In an image forming apparatus such as a multi-functional peripheral provided with various forms of modes such as copy, scan and facsimile modes, and various forms of setting parameters for each mode, operations are complicated and much time is required when a job involving a great number of settings is to be set. One of the techniques for simplifying the setting operations of such a job is the method disclosed in the Japanese Unexamined Patent Application Publications Nos. 2001-243031 and 2005-45337, wherein the information of the job having been set is stored and is used to display the job history, and the setting of the job selected by a user from this history display is reflected on the setting of a new job, or the settings of the element (processing conditions) of the selected job is changed.

However, there is a restriction on the type of objects to be operated: namely, the aforementioned conventional technique allows the operation of only a specific job whose history is displayed, or a specific element constituting the job. To put it another way, the conventional technique merely allows the setting of the specific job to be used, or permits the setting of the specific element constituting the job to be changed. The conventional technique is characterized by a narrow range in the selection of the job or element that can be used for the setting of a new job. Thus, such a conventional method fails to ensure an effective setting of a new job made up of a great number of elements, for example.

The object of the present invention is to solve the aforementioned problems and to provide an information processing apparatus and program wherein the elements for a plurality of jobs among the elements set already are displayed and the elements selected from two or more of these jobs are reflected on the setting of a new job.

### SUMMARY OF THE INVENTION

One aspect of the present invention is an image processing apparatus having: an operation section which accepts a job setting operation; a memory section which memorizes an element of a job set through the operation section; a display section, and a controller, wherein the controller is configured to control the display section to display a plurality of jobs so as to display elements memorized in the memory section of the plurality of jobs on the display section, accept selecting elements from two or more jobs of the plurality of jobs through the operation section, and generate a new job including the elements selected.

Another aspect of the present invention is a computer readable media storing a program to make an image processing apparatus having an operation section, a memory section, and a display section, execute a method comprising: accepting a setting operation of a job through the operation section; memorizing an element of the job set through the operation section in the memory section; displaying a plurality of jobs so as to display elements memorized in the memory section of the plurality of jobs on the display section; accepting selecting elements from two or more jobs of the plurality of jobs through the operation section; and generating a new job including the elements selected.

Another aspect of the present invention is a method for controlling an image processing apparatus having an operation section, a memory section, and a display section, the method having: accepting a setting operation of a job through the operation section; memorizing an element of the job set through the operation section in the memory section; displaying a plurality of jobs so as to display elements memorized in the memory section of the plurality of jobs on the display section; accepting selecting elements from two or more jobs of the plurality of jobs through the operation section; and generating a new job including the elements selected.

### BRIEF DESCRIPTION OF THE DRAWINGS

FIG. 1 is a diagram representing the system configuration of an image forming apparatus (information processing apparatus) in the first embodiment of the present invention;

FIG. 2 is a block diagram representing the schematic configuration of a multi-functional peripheral as an image forming apparatus (information processing apparatus) in the first embodiment of the present invention;

FIG. 3 is a diagram representing an example of a structure of the job history table in the first embodiment of the present invention;

FIG. 4(A) is an explanatory diagram representing the job history display screen of an execution order-based in the first embodiment of the present invention;

FIG. 4(B) is an explanatory diagram representing the job history display screen of number-of-elements-based display mode in the first embodiment of the present invention;

FIG. 4(C) is an explanatory diagram representing a new job generation verification screen in the first embodiment of the present invention;

FIG. 5 is a flow chart representing the main processing of job history display and new job generation in the first embodiment of the present invention;

FIG. 6 is a flow chart representing the history display/element selection processing as one of the sub-processing steps in the main processing of FIG. 5

FIG. 7 is a diagram representing an example of the structure of the job history display data table of the execution order based display mode created by history display/element selection processing in FIG. 6;

FIG. 8 is a diagram representing an example of the structure of the job history display data table of the number-of-elements-based display mode created by history display/element selection processing in FIG. 6;

FIG. 9 is a flow chart showing new job generation as one step in the sub-processing of the main processing in FIG. 5;

FIG. 10(A) is an explanatory diagram representing the job history display screen of an execution order-based in the second embodiment of the present invention;

FIG. 10(B) is an explanatory diagram representing the Job history display screen in the job mode based display mode in a state where the new job can not be generated in the second embodiment of the present invention;

FIG. 10(C) is an explanatory diagram representing the Job history display screen in the job mode based display mode in a state where the new job can be generated in the second embodiment of the present invention;

FIG. 10(D) is an explanatory diagram representing a new job generation verification screen in the second embodiment of the present invention, wherein combining FIGS. 10(A) to 10(D) constitutes an explanatory diagram showing the screen transition when generating a new job using a job mode based display mode in the second embodiment of the present invention;

FIG. 11(A) is an explanatory diagram representing the job history display screen of an execution order-based in the second embodiment of the present invention;

FIG. 11(B) is an explanatory diagram representing the Job history display screen in the job element priority display mode in a state where the new job can not be generated in the second embodiment of the present invention;

FIG. 11(C) is an explanatory diagram representing the Job history display screen in the job element priority display mode in a state where the new job can be generated in the second embodiment of the present invention;

FIG. 11(D) is an explanatory diagram representing a new job generation verification screen in the second embodiment of the present invention, wherein combining FIGS. 11(A) to 11(D) constitutes an explanatory diagram showing the screen transition when generating a new job using the job element priority display mode in the second embodiment of the present invention; and

FIG. 12 is a flow chart showing the history display/element selection processing in the second embodiment of the present invention.

### PREFERRED EMBODIMENT OF THE INVENTION

### Preferred Embodiment of the Present Invention

The following describes the embodiments of the present invention with reference to the drawings.

### Embodiment 1

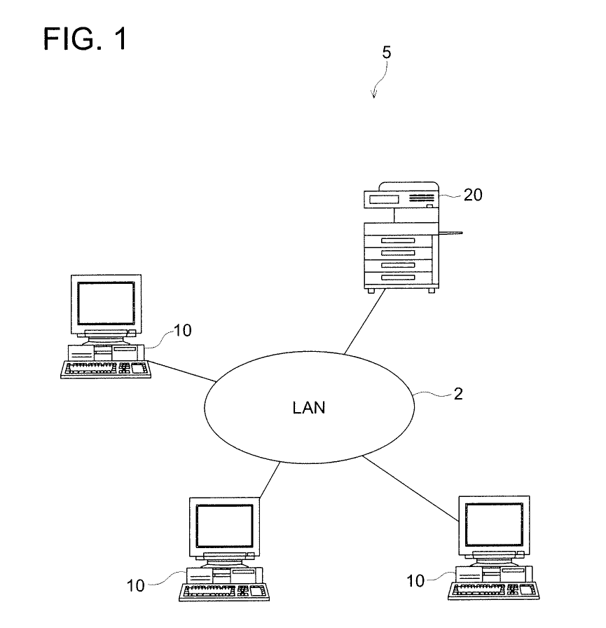

FIG. 1 shows the system configuration of an image forming apparatus 5 (information processing apparatus) in the first embodiment of the present invention. The image forming system 5 includes a desired number of terminals 10 and a multi-functional peripheral (MFP: Multi Function Peripheral/Multi Function Printer) 20 as the image forming apparatus (information processing apparatus) accessed from each of the terminals 10, which are connected to the network 2 such as LAN (Local Area Network). The multi-functional peripheral 20 is provided with a document copy function, printing function, scan function, facsimile function, box function, and file transfer functions such as Scan-to-E-mail transmission, Scan-to-SMB (Server Message Block) transmission and Scan-to-FTP (File Transfer Protocol) transmission. The terminal 10 access the multi-functional peripheral 20 through the network 2 and is used to make a request of various forms of jobs such as a printing job or a request for operations. The terminal 10 is formed by incorporating a driver program of the multi-functional peripheral 20 into a personal computer, for example.

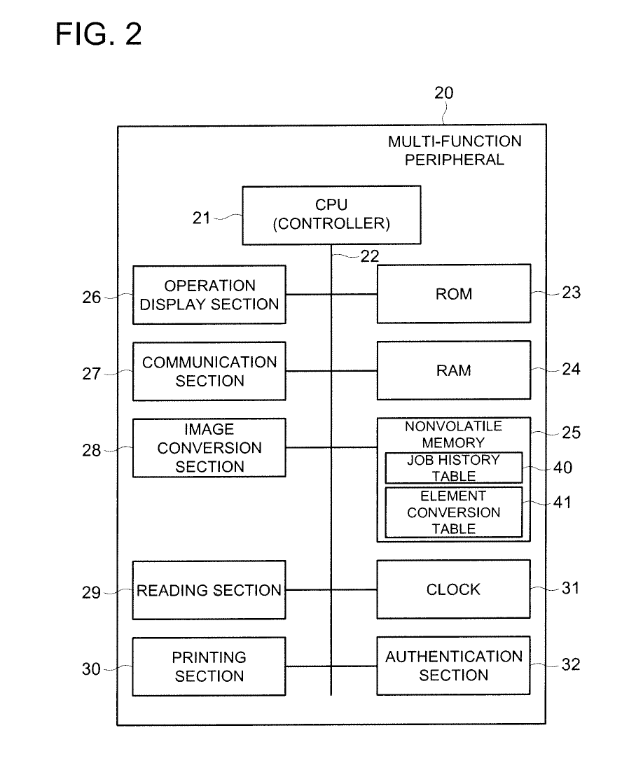

FIG. 2 shows the schematic configuration of a multi-functional peripheral 20. The multi-functional peripheral 20 includes the CPU (Central Processing Unit) 21 as a controller which is connected with the ROM (Read Only Memory) 23, RAM (Random Access Memory) 24, nonvolatile memory 25, operation display section 26, communication section 27, image conversion section 28, reading section 29, printing section 30, clock 31, and authentication section 32 via a bus 22.

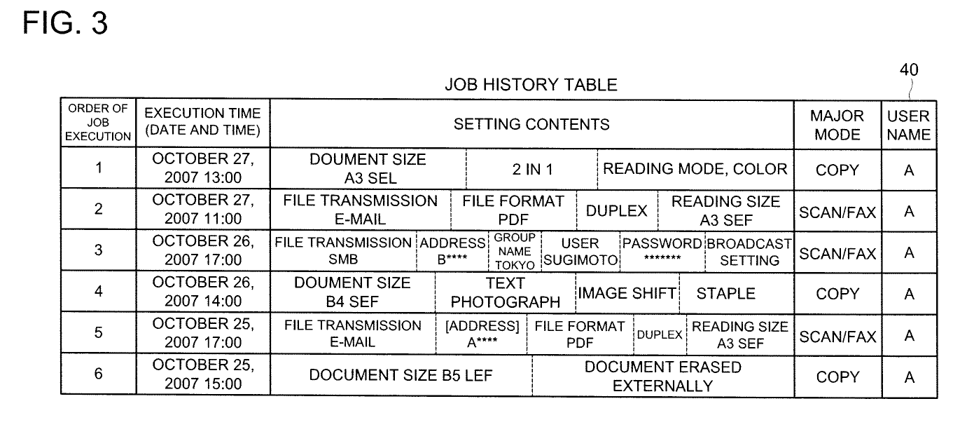

The CPU 21 controls the operations of the multi-functional peripheral 20 based on the program stored in the ROM 23. The RAM 24 is used as a work memory for storing various forms of data on a temporary basis. When the program is executed by the CPU 21, the RAM 24 is also used as an image memory for saving image data. The nonvolatile memory 25 is a memory for storing the information even after the power has been turned off. It stores the job history table 40 (FIG. 3) to be described later, the element conversion table 41, screen data to be displayed on the operation display section 26, the transition table, and user authentication information.

The operation display section 26 performs the function of a display section for displaying various forms of operation screens and guide screens for the user. It also performs a function as an operation section for receiving various operations from the user. In this case, the operation display section 26 performs the operation function. Here the operation display section 26 is made up of a liquid crystal display, a touch panel arranged on the screen thereof, and various types of switches such as a start key (execution key), history verification key, and display mode switching key. The communication section 27 communicates with an external apparatus such as a terminal 10 via the network 2.

The reading section 29 optically reads out a document and acquires image data. The reading section 29 includes, for example, a light source for irradiating the document, an image sensor for receiving the light reflected from the document and reading the document by one line across the width, a scanning mechanism for ensuring that the position to be read out by the image sensor in units of line is moved along the length of the document, and an optical path consisting of a lens and mirror for leading the light reflected from the document to the image sensor to form an image. The image conversion section 28 applies an image processing function to image data, whereby the image is corrected, rotated, enlarged, reduced, compressed, and expanded.

The printing section 30 prints the image corresponding to the inputted image data and outputs it onto the recording paper. For example, the printer section 30 has a recording paper conveyance apparatus, photoreceptor drum, charging device, laser unit, development apparatus, transfer separation apparatus, cleaning apparatus, fixing apparatus and others, and is formed as a laser printer for forming an image on the recording paper using an electrophotographic process.

The clock 31 measures the points of time. The authentication section 32 acquires the authentication data and authenticates a user in conformity to the authentication information registered in advance. This user authentication employs various forms of general-purpose authentication techniques independently or in combination, such as a card authentication technique wherein the authentication data stored in the IC (Integrated Circuit) card and ID (Identification) card is read out and is compared with the authentication information registered in advance, whereby personal authentication is carried out; and a biological authentication technique wherein the biological information of fingerprints and finger veins is read as the authentication data and is compared with the authentication information registered in advance, whereby personal authentication is carried out.

The CPU 21 serves as a controller in such a way that a job set by the operation of the operation display section 26 is generated by execution of a program, the information for displaying the history of the set job on the operation display section 26 is stored in the nonvolatile memory 25, the job setting operation screen and the job history—the elements of the already set job, to put it more specifically—are displayed for a plurality of jobs on the operation display section 26, the selection of the elements from two or more of a plurality of jobs displayed on the operation display section 26 is accepted, the element of the selected job is converted according to the element conversion table 41, and a new job including the selected element is generated.

The job element (constituent element) can be defined as individual processing conditions constituting all the processing conditions for a series of job processes. It includes the job mode and the parameter thereof. To put it more specifically, the mode includes the copy mode, scan-to-file transmission mode, facsimile mode, and box mode. The mode parameter for the copy mode includes the document size (e.g., A4, A3, B5, or B4), paper feed direction (sheet feed in the longitudinal or lateral direction), printing surface (simplex or duplex), and layout (1 page, 2 page (2 in 1), 4 page (4 in 1) , etc.). The mode parameter for the scan-to-file transmission mode includes the type of transmission (E-mail transmission, SMB transmission, FTP transmission, etc.), address (a plurality of addresses in the case of a broadcast transmission), file format (PDF format (Portable Document Format (registered trademark)), TIFF format (Tagged Image File Format (registered trademark)), etc.), the size and direction of reading, and the side to be read (simplex or duplex). As described above, the job element includes the mode elements and parameter elements.

To set the jobs of a great number of variations made up of the aforementioned multiple types of elements, the multi-functional peripheral 20 includes a plurality of operation screens which are switched and displayed on the operation display section 26. When power is on, a default screen such as the operation panel is displayed, and the default screen can be shifted to any one of various types of screens.

The default screen or various types of operation screens displayed on the operation display section 26 display the buttons and icons for switching among the screens, and for selecting and setting the job element (processing conditions). In response to the operation of depressing the buttons and icons on the screen displayed on the operation display section 26, the multi-functional peripheral 20 switches among the screens and selects and sets the job element. Further, the screen switching operation (shift operation) is performed according to the screen data stored in the nonvolatile memory 25 and the screen transition table.

FIG. 3 shows an example of a structure of the job history table 40 stored in the nonvolatile memory 25 by the job setting operation of the user.

The job history table 40 registers the information of the job set by the user. The information registered in the job history table 40 is used for the job history display, and is also employed to set a new job to be generated. This job history table 40 registers the job execution order based data, execution time point (date and time) data, setting description data, and major mode data, which are associated and stored in job units. User authentication is carried out by the authentication section 32. When the user is specified, the data on the authenticated user name is also registered in the associated form.

The execution time point (date and time) data is the time point (date and time) information data obtained by the CPU 21 from the clock 31 at the time of job execution. The job execution order based data indicates the serial numbers assigned automatically by the CPU 21 sequentially starting from the newest job at the execution time point. The serial numbers consists of 1 through N starting from 1, for example.

The setting description data includes the description of the job setting. To be more specific, it is the data (element data) on individual elements of the set jobs, namely, the data on the job mode and the parameter thereof (mode data, parameter data, etc.). For example, default element data is registered for the elements not yet set by the user. The set element data is registered for the elements having been set by the user. The element having been set by the user is additionally provided with the set identification information (not illustrated) showing that the element has been set. In the drawing, the default element data is not illustrated. Only the elements data having been set are illustrated. To put it another way, what is illustrated in the drawing is the mode data that has been actually set by the mode setting operation of the user, and the parameter data actually set by the parameter setting operation of the user for that mode.

The major mode data is used to classify the jobs for each major mode (for each of the predetermined types). The major mode indicates the top category indicating the job type. The major mode is exemplified by the copy mode (“COPY” in the drawing), scan-to-file transmission mode/facsimile mode (“Scan/Fax” in the drawing), and box mode. These major modes are set in a predetermined manner (initial setting). It is also possible to arrange such a configuration that the major mode can be selected and set by the administrator, the multi-functional peripheral 20, or the user. The CPU 21 automatically determines the major mode of the job according to the job mode having been set by the user and registers the major mode data.

The user name data indicates the name of the user having set the job, and is exemplified by the user name registered in the form associated with the authentication information. This user name data is registered in the form associated with the data including the aforementioned setting description data, whereby the job history table 40 stores for each user the setting description (element) of the job set by the authenticated user.

FIG. 3 shows the job history table 40 wherein six types of jobs have been set by the user A of the multi-functional peripheral 20 after having performed user authentication every time at a desired time point. The following shows the details of the setting description of each job (description of the setting operation actually performed by user A).

The first job is a copy job, and the setting description is [document size A3 Sef (Short Edge Feed; paper fed in the longitudinal direction)] [2 in 1] [read-in mode color]. The second job is a Scan-to-E-mail transmission job and the setting description is [file transmission E-mail] [file format PDF] [duplex] [read-in size A3 Sef]. The third job is the Scan-to-SMB multiple address transmission job, and the setting description is [file transmission SMB] [address B****] [group name tokyo] [user sugimoto] [password *******] [multiple address setting (address/group name/user/password)]. The fourth job is a copy job and the setting description is [document size B4 Sef] [text photograph] [image shift] [staple]. The fifth job is a Scan-to E-mail transmission job, and the setting description is [file transmission E-mail] [address A****] [file format PDF] [duplex] [read-in size A3 Sef]. The sixth job is a copy job and the setting description is [document size B5 Lef (Long Edge Feed; paper fed in the lateral direction)] [Erasure outside of document].

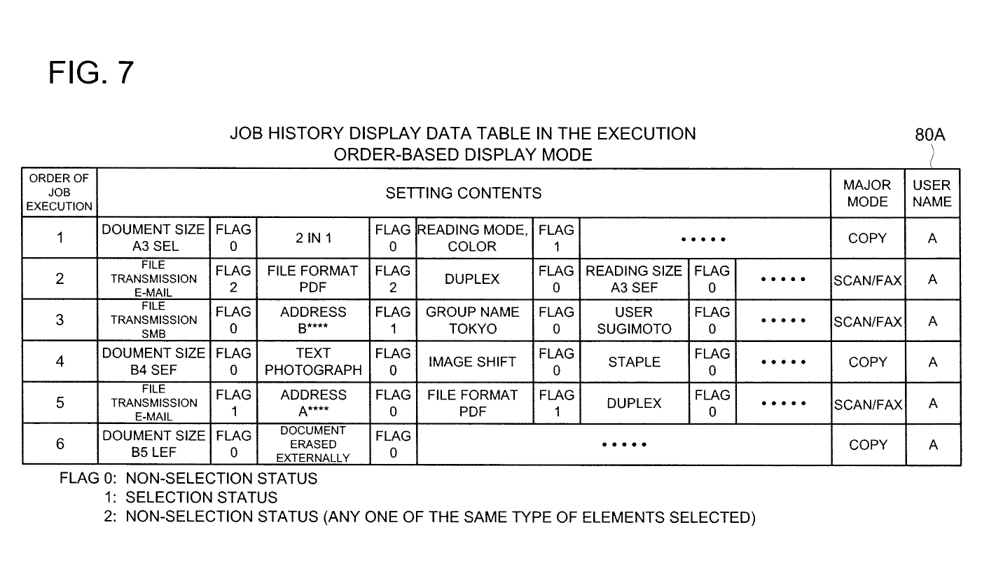

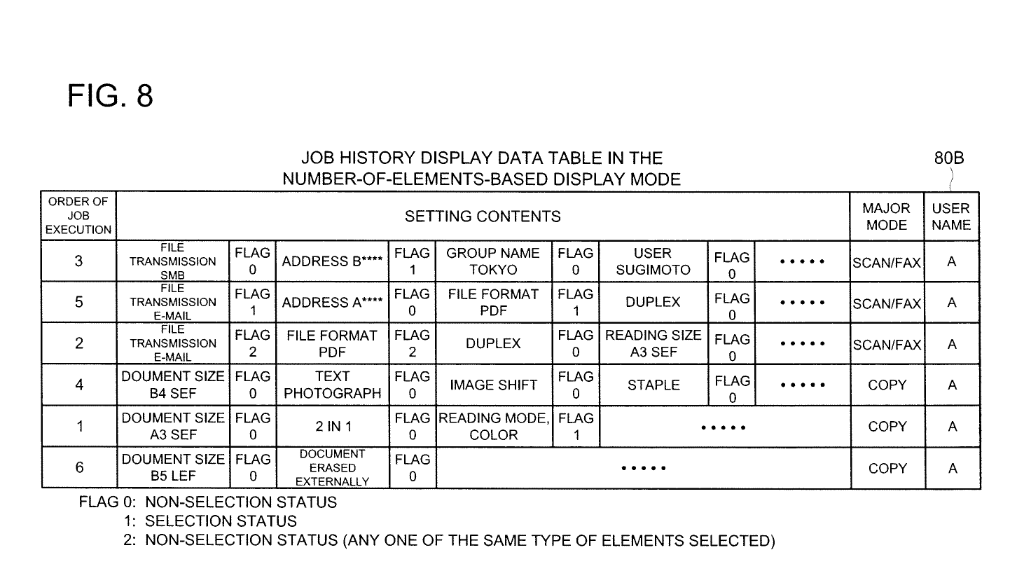

When the history verification key (not illustrated) has been pressed, the multi-functional peripheral 20 creates the job history display table (FIG. 7 and FIG. 8) to be described later, using the information (table data) registered in the job history table 40, and displays the history of the jobs having been set and executed, using the job history display table, in job units on the operation display section 26 in a predetermined order (job history display screen). The job order display mode includes the execution order based (time-series) display mode wherein display is performed sequentially from the higher level to the lower level, starting from the newest job at the execution time point, and the number-of-elements-based display mode wherein display is performed sequentially from the higher level to the lower level, starting from the job having the greatest number of elements. These display modes can be switched by setting (nonvolatile setting) of the display mode switching dip switch (Dip SW) (not illustrated) arranged inside or on the back of the multi-functional peripheral 20, or by pressing the display mode switching key (hard key) (not illustrated) arranged on the operation display section 26.

Elements are displayed for each job on the job history display screen according to the aforementioned two display modes, and each element can be selected independently (by pressing the button). The multi-functional peripheral 20 is capable of ensuring that the element selected on the job history display screen is reflected on the setting of a new job (whereby the element of a new job is selected). The setting is reflected onto a new job, for example, when the data of the element having been selected is copied to the mode/parameter table of the new job.

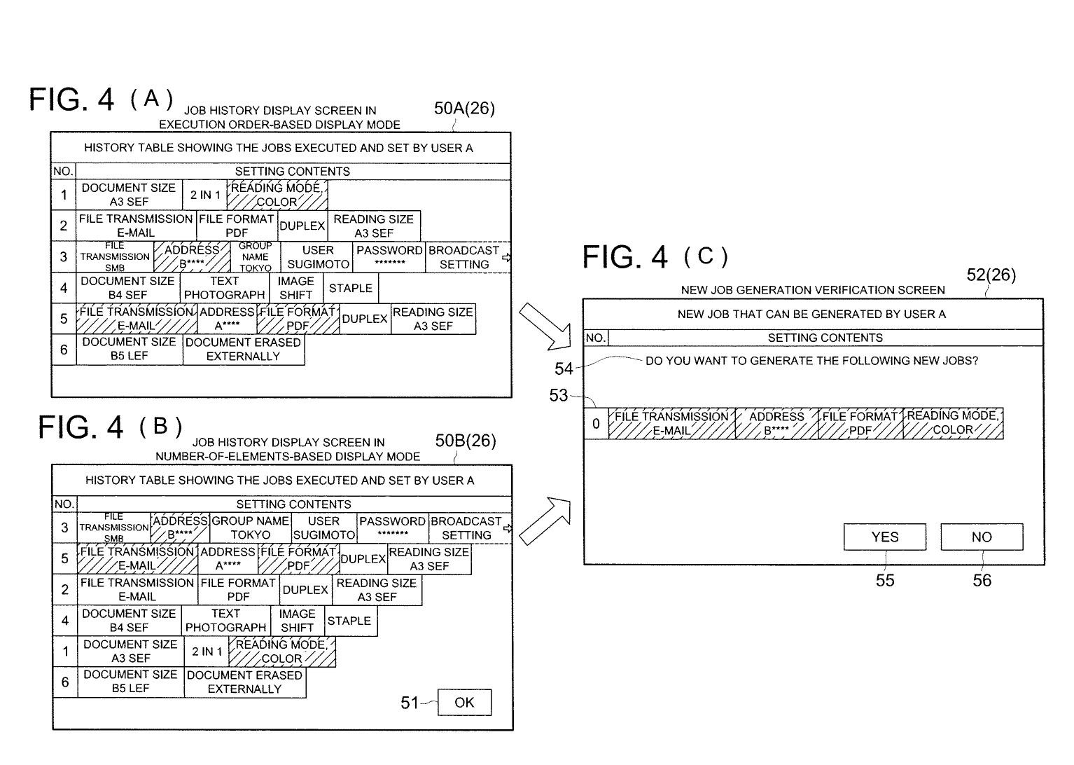

FIG. 4(A) shows an example of the job history display screen 50A in the execution order based display mode. FIG. 4(B) shows an example of the job history display screen 50B in the number-of-elements-based display mode. The job history display screens 50A and 50B are displayed on the operation display section 26 using the job history display table created by the information registered in the job history table 40 of FIG. 3. FIG. 4(C) shows an example of the new job generation verification screen 52 displayed on the operation display section 26 before generating the new job composed of the elements selected by the job history display screens 50A and 50B.

The execution order number (No) and the setting description (element) of the job having been set and executed in the multi-functional peripheral 20 are displayed in units of job on the job history display screens 50A and 50B. If user authentication has not been completed, a predetermined number of jobs (the number of jobs that can be displayed) are selected from among all the jobs having been set and executed, and the history thereof is displayed. If user authentication has been completed, a predetermined number of jobs (the number of jobs that can be displayed) are selected from among all the jobs having been set and executed by the authenticated user, and the history thereof is displayed. The user name is also displayed in the title column. For example, when user A is operating the multi-functional peripheral 20 subsequent to user authentication, the display shown in FIGS. 4(A) and (B) appears on the title columns of the job history display screens 50A and 50B.

A tabulated list of job setting descriptions is displayed according to the time point of execution on the job history display screen 50A in the execution order based display mode. In this example, the setting descriptions of job 1 through job 6 having been set and executed by user A are arranged in descending order of job numbers from top to bottom.

A tabulated list of jobs is given in order of the number of elements on the job history display screen 50B in the number-of-elements-based display mode. If there is a plurality of jobs having the same number of elements, the display priority is given to a job having a newer time point of execution. In this example, the setting descriptions of job 1 through job 6 having been set and executed by user A are shown in the form of a tabulated list of jobs, which is displayed as “job 3, job 5, job 2, job 4, job 1 and job 6” from top to bottom in descending order of the number of elements, and in descending order of the time point of execution if the number of elements is the same.

When the history verification key is pressed, the display mode (either in order of execution specified by the setting of dip switches or in order of the number of elements) is automatically selected. The job history display screen 50A in the execution order based display mode or job history display screen 50B in the number-of-elements-based display mode is displayed on the operation display section 26. When the job history display screen 50A or 50B is displayed, the display mode can be manually changed to the execution order based mode or the number-of-elements-based mode by pressing the display mode switching key.

The job setting description—i.e., each element—displayed on the job history display screens 50A and 50B can be selected by pressing the key. The selected element is then changed to exhibit the display status indicating that the element has been selected. In FIGS. 4(A) and (B), the element in the non-selected status is shown in low density (colorless), and the element in the selected status is displayed in high density (colored), and is shown schematically by hatching. On the illustrated job history display screens 50A and 50B, the selected status includes the [read-in mode color] of job 1, [address B****] of job 3, and [file transmission E-mail] and [file format PDF] of job 5.

As described above, when the element has been selected, the display density and display color are changed. When the element in the selected status has been re-selected, selection is released, and the status changes back to the original display status which is the non-selected status. Such a change in the display status in response to the actual selected/non-selected status allows the user to easily identify the selected element from the non-selected element.

Further, if a plurality of the same elements is displayed on the job history display screens 50A and 50B, only one of them can be selected. In this example, job 2 and job 5 include the elements of the [file transmission E-mail], [file format PDF], and [duplex]. Either job 2 or job 5 is allowed to select these elements. For example, when the [file transmission E-mail] and [file format PDF] of job 5 are in the selected status, as shown in FIGS. 4(A) and (B), and the [file transmission E-mail] or [file format PDF] of job 2 have been selected, these elements are changed into the selected status, the [file transmission E-mail] or [file format PDF] of job 5 are automatically changed to the non-selected status.

The elements selected as the second and later ones are changed according to the element conversion table 41 if there is a difference between the major mode (type) of the job at the source of selection and the major mode of the currently set job (a new job to be generated). The element conversion table 41 converts the inputted element according to a predetermined conversion rule, and outputs the result. The predetermined conversion rule is, for example, made of the input/output association table that registers the inputted element and the element to be outputted in the form associated with the major mode of the job. This predetermined conversion rule (input/output association table) can be set in advance (by initial setting), or can be determined and set as desired by the administrator or user of the multi-functional peripheral 20. Using the relevant element and the major mode of the currently set job as the input parameters, the element conversion table 41 outputs the corresponding element by reference to the conversion rule.

The following describes the conversion of the element with reference to the case of changing the [duplex] (duplex printing) of the copy job into the [duplex] (duplex read-in) of the scan job.

The [duplex] of the copy job performs duplex printing of the image of the document read by the reading section 29, and outputs the result onto the recording paper using the printing section 30. The [duplex] of the scan job is capable of reading the duplex image of the document using the reading section 29. The function is different according to the major mode (type) of the job even in the case of the same [duplex]. Thus, the [duplex] of the copy job is changed into the [duplex] of the scan job when used for the scan job.

For example, the conversion rule (input/output association table) is set in such a way that, when the [duplex] of the copy job has been inputted as the element and the [scan] has been inputted as the major mode of the job, the element conversion table 41 outputs the [duplex] of the scan job.

If the [duplex] of the copy job (not illustrated) is set when the user has first selected the [file transmission *****] on the job history display screens 50A and 50B, and has set the scan job (the job in the scan-to-file transmission mode), then there is a difference between the major mode of the job ([copy mode]) at the source of selection of that [duplex] and the major mode ([scan mode]) of the currently set job. In this case, the [duplex] of the copy job (currently selected element) and the [scan mode] as the major mode (the major mode of the job including the element having been selected as the first one) of the currently set job are inputted into the element conversion table 41. Using them as the input parameters, the element conversion table 41 outputs the [duplex] of the scan job by reference to the conversion rule. This [duplex] is added as the element of the currently set scan job.

Conversely, when the [duplex] of the scan job (duplex read-in) is changed into the [duplex] of the copy job (duplex printing), the conversion rule (input/output association table) of the element conversion table 41 should be set in such a way as to output the [duplex] of the copy job, when the [duplex] of the scan job is inputted as an element and the [copy mode] is inputted as the major mode of the job. This procedure allows the [duplex] of the scan job and the [copy mode] as the major mode of the currently set job to be inputted into the element conversion table 41, if the user has selected the [duplex] of the scan job when the copy job is set. The element conversion table 41 outputs the [duplex] of the copy job by reference to the conversion rule using them as the input parameters.

Further, when the [duplex] of the copy job (duplex printing) has the function of specifying the read-in mode of the document, namely, the function of the simple read-in, duplex printing of the document or the duplex read-in, duplex printing of the document, it is also possible to arrange such a configuration that the [duplex] of the scan job is changed into the [duplex] of the copy job having either of these functions. The conversion rule in this case can be set in advance or can be determined and set as desired by the administrator or user.

When job can generated by the selected element, the OK button 51 (job generation executing key) is displayed on the job history display screens 50A and 50B. This OK button 51 is not displayed if the job cannot be generated due to the presence of insufficient elements when a plurality of elements has been selected. The display is made only when the required elements have been made available and the job can be generated. The aforementioned function of switching between the display/non-display of the OK button 51 in response to the possibility of job generation allows the user to easily identify whether or not the job can be generated by the currently selected element.

When the OK button 51 of the job history display screens 50A and 50B has been pressed, the display screen of the operation display section 26 is changed over to the new job generation verification screen 52. The setting description (each element) of the new job 53 made up of the elements selected on the job history display screens 50A and 50B is displayed on the new job generation verification screen 52. At this time point, the new job 53 is not yet generated and the job number is “0”. In this example, the job 0 made of the [file transmission E-mail], [address B****], [file format PDF] and [read-in mode color] is displayed as the new job 53 that can be generated.

A new job generation verification message 54 as exemplified by “Do you want to generate the following new job?”, an execution button 55 for generating the new job 53 which carries a message “Generate”, and a cancel button 56 for canceling the generation of the new job 53 which carries a message “Not generate”, are displayed on the new job generation verification screen 52. This procedure allows the user to finally verify the element of the new job 53 to be generated, by observing the setting description of the new job 53 displayed on the new job generation verification screen 52.

When the execution button 55 has been pressed, the new job 53 made up of the elements displayed on the new job generation verification screen 52 is generated. When the cancel button 56 has been pressed, the generation of the new job 53 is cancelled. After the operation of these buttons, the display screen of the operation display section 26 is switched over to the default screen, or to the operation screen displayed immediately before the display of the job history display screens 50A and 50B. In addition to such a screen shift, it is also possible to arrange such a configuration that, when the execution button 55 or cancel button 56 has been pressed, the display screen of the operation display section 26 goes back to the job history display screens 50A and 50B, and the aforementioned element selection operation is repeated after that, whereby using the element of the job having been set and executed as a new job is additionally generated or is re-generated.

Referring to the flow chart, the following describes the job history display and the processing of new job generation to be executed by the multi-functional peripheral 20.

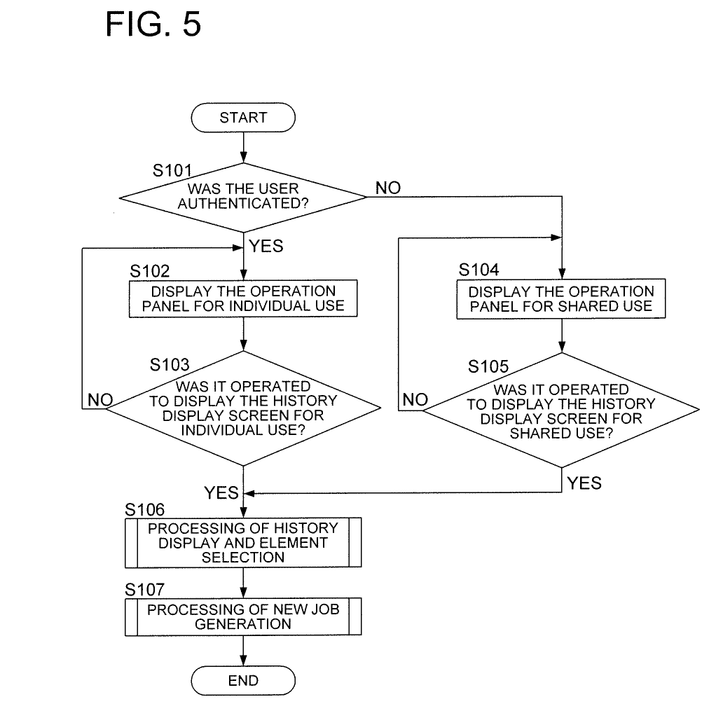

FIG. 5 shows the job history display and main processing of the new job generation to be performed by the multi-functional peripheral 20. When this main processing has started (Start), the CPU 21 determines if user authentication has been performed or not (Step S101).

If user authentication has been performed (Step S101; Yes), the CPU 21 displays an individual operation panel (default screen for individual user) on the operation display section 26 (Step S102), and monitoring is performed to check whether or not the job history display screen display operation has been completed, namely, whether or not the history display key has been pressed (a loop from “No” of Step S103 to Step S102). If user authentication has not yet performed (Step S101; No), the CPU 21 displays the operation panel for shared use (default screen for shared use) on the operation display section 26 (Step S104), and monitoring is performed to check whether or not the job history display screen display operation has been performed (a loop from “No” of Step S105 to Step S104).

When the job history display screen display operation has been performed (Step S103; Yes/Step S105; Yes), the CPU 21 executes the sub-processing of history display/element selection (Step S106) and new job generation (Step S107), whereby the main processing terminates (End).

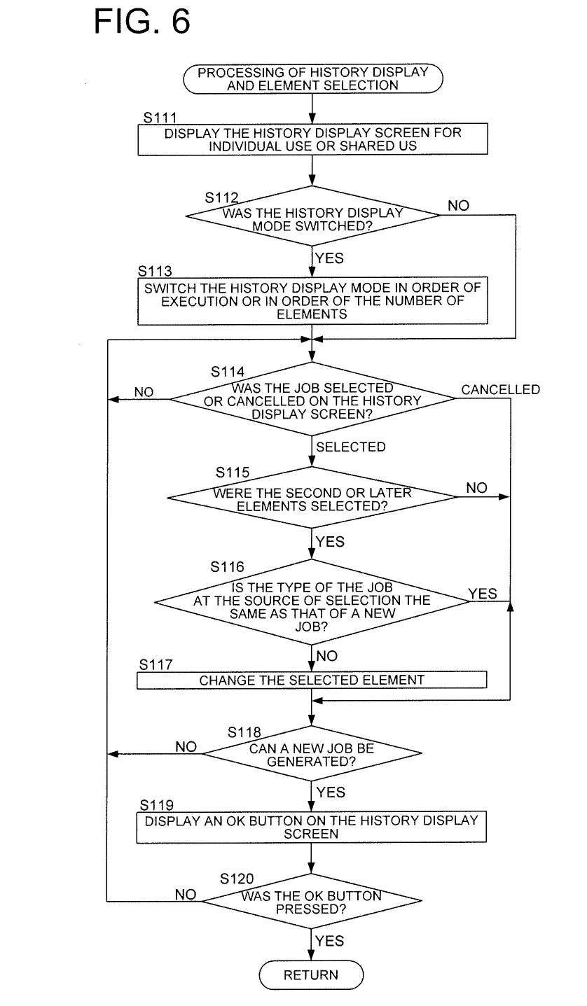

FIG. 6 shows the sub-processing of history display/element selection (Step S106 of FIG. 5) in the aforementioned main processing. Upon start of this sub-processing, the CPU 21 acquires the history display table data for individual use or for shared use from the job history table (FIG. 3), and creates a job history display data table in the work area of the RAM 24 using the table data. When acquiring the table data for individual use, the CPU 21 acquires the table data of the job having been set and executed by the authenticated user—to be more specific, job execution order based data, element data provided additionally with the set identification information in the setting description data (only the data of the element having been actually set, except for the default element data), major mode data, and user name data according to the user name data registered in the job history table. When acquiring the table data for shared use, the CPU 21 acquires the table data of all the jobs registered in the job history table—to be more specific, job execution order based data, the element data provided additionally with the set identification information in the setting description data, and major mode data.

FIG. 7 shows the job history display data table 80A of the execution order based display mode created on the RAM 24 by the CPU 21. FIG. 8 shows the job history display data table 80B of the number-of-elements-based display mode created on the RAM 24 in a similar manner. These job history display data tables 80A and 80B were created by using the table data for individual use acquired from the job history table 40 of FIG. 3, when user A performed display operation of the job history display screen after having been subjected to user authentication on the multi-functional peripheral 20, as described above. Further, either the job history display data table 80A or 80B is created on the RAM 24 in response to the execution order based or number-of-elements-based display mode set by the dip switch.

The job execution order based data, setting description data, and major mode data are registered in the job history display data tables 80A and 80B on the associated form in job units. When the user is specified by user authentication as in this example, the user name data is also registered on the associated form. Further, in the job history display data table 80A of the execution order based display mode, the job data is registered from top to bottom in order of execution starting from the newest one. In the job history display data table 80B of the number-of-elements-based display mode, job data is registered from top to bottom in the descending order of the number of elements.

To put it more specifically, the setting description data is the data of individual elements of the set job (e.g., mode data and parameter data), similarly to the case of the job history table 40. The element data includes the flags indicating the selected/non-selected status and these flags are registered in the associated form. Flag 0 indicates the non-selected status of the element and flag 1 indicates the selected status of the element. Flag 2 shows that the element is in the non-selected status and one of the elements having the same type as this element is in the selected status. When job history display data tables 80A and 80B are created, all flags are set to 0 by the CPU 21 (initial status). When the element displayed on the job history display screens 50A and 50B is selected or the selection thereof is cancelled, the flag values of the element having received the operation and the related elements are changed.

Using the aforementioned job history display data tables 80A and 80B, the CPU 21 allows the job history display screen for individual use or shared use (FIGS. 4(A) and (B)) to be displayed on the operation display section 26 (Step S111 of FIG. 6) in the display mode in order of execution or in order of the number of elements as having been set by the dip switch. In this case, all the jobs are displayed if the number of jobs registered in the job history display data table does not exceed the number of the jobs that can be displayed. If the number of jobs exceeds the number of jobs that can be displayed, the jobs in the number that can be displayed are extracted from the top of the job history display data table and are displayed. To be more specific, in the execution order based display mode, the jobs in the number that can be displayed are selected starting from the newest job in order of execution and are displayed. In the number-of-elements-based display mode, the jobs in the number that can be displayed are selected starting from the job containing the greatest number of elements, and are displayed.

When the display mode of the job history display screen (history display mode) has been switched after the display on the job history display screen, to put it another way, when the display mode switching key has been pressed (Step S112; Yes), the CPU 21 rearranges the jobs registered in the job history display data table and switches the job history display screen from the current display mode (initial setting display mode by the dip switch) to another display mode (Step S113).

To put it more specifically, when the display mode switching key has been pressed in the execution order based display mode, the jobs arranged in order of execution on the job history display data table are rearranged in the descending order of the number of elements, and the job history display screen of the number-of-elements-based display mode is displayed using this job history display data table. When the display mode switching key has been pressed in the number-of-elements-based display mode, the jobs arranged on the job history display data table in the descending order of the number of elements are rearranged in order of execution, and the job history display screen of the execution order based display mode is displayed using this job history display data table. The display mode of the job history display screen is switched every time the display mode switching key is pressed. Further, when the display mode switching operation is not performed after display of the job history display screen (Step S112; No), the CPU goes to Step S114.

During the display of the job history display screen, the CPU 21 checks on the job history display screen to see whether or not the job element has been selected or the selection has been cancelled (a loop from “No” in Step S114 to Step S114).

When the element has been selected, the CPU 21 changes the flag of the selected element from 0 to 1 on the job history display data table. Further, the element of the same type as that of the selected element is present in the job history display data table, the CPU 21 changes the flag of the element having the same type from 0 to 2. When the element with flag 2 set thereon has been selected, the CPU 21 changes the flag of the selected element from 2 to 1, and changes the flag of the element having the same type as that of the selected one and having the flag set to 1 so that flag 1 is changed to flag 2.

When the selection of the element has been cancelled, the CPU 21 changes the flag of the element whose selection has been cancelled, from 1 to 0 on the job history display data table. Further, if the element having the same type of the element whose selection has been cancelled is present in the job history display data table, the CPU 21 changes the flag of the element of the same type from 2 to 0.

According to this flag, the CPU 21 controls the display showing the selected/non-selected status of each element. To be more specific, the element in the non-selected status having a flag 0 or 2 is displayed in low density (colorless), and the element in the selected status having a flag 1 is displayed in high density (colored).

Further, when an element has been selected (Step S114; Selected), the CPU 21 determines whether or not that element is the second or later selected element (Step S115). If it is the second or later selected element (Step S115; Yes), the CPU 21 determines whether or not the type (major mode) of that element at the source of selection is the same as the currently set type (major mode) of the new job (Step S116).

If the type is not the same (Step S116; No), the CPU 21 changes the selected element into the element that can be used in the new job (Step S117), and goes to the next Step S118.

The element is changed using the aforementioned element conversion table 41. To be more specific, the CPU 21 inputs the currently selected element and the currently set type (major mode) of the new job into the element conversion table 41. Using this element and the type of new job as input parameters, the element conversion table 41 refers to the conversion rule and outputs a predetermined element that can be used in a new job.

The CPU goes to Step S118 when the selection of the element has been cancelled (Step S114; Cancelled), when the selected element is the first element to have been selected (Step S115; No), and when the type of job at the source of selection of the selected element is the same as that of the currently set new job (Step S116; Yes).

In Step S118, the CPU 21 determines if a new job can be generated or not by the currently selected element. This decision is made, for example, by registering the required minimum elements in advance for each job mode and checking this registered information against the currently selected element.

If it has been determined that the new job cannot be generated (Step S118; No), the CPU goes back to Step S114, and the CPU 21 continues to monitor the operation of selecting the element of the job displayed on the job history display screen or the operation of canceling the selection of that element. If it has been determined that the new job can be generated (Step S118; Yes), the CPU 21 allows the OK button to be displayed on the job history display screen (Step S119).

The new job can be generated only by the element selected at this time point. An element can be added in some cases. Further, the selection of the incorrectly selected element is cancelled or a different element is re-selected in some cases. When the element in the non-selected status is additionally selected or the selection of the element in the selected status is cancelled (Step S120; No through Step S114; Selected/Cancelled) as in these cases, without the OK button being pressed on the job history display screen, then the CPU 21 again executes Step S114 and thereafter. When the OK button on the job history display screen has been pressed (Step S120; Yes), the CPU terminates this sub-processing (history display/element selection processing) and goes back to the main processing of FIG. 5 (Return).

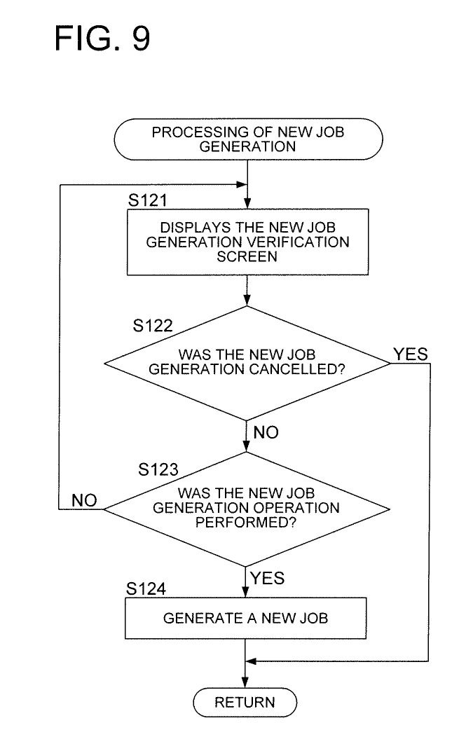

FIG. 9 shows the sub-processing (Step S107 of FIG. 5) of generating a new job in the main processing of FIG. 5. Upon the start of this sub-processing, the CPU 21 allows the new job generation verification screen (FIG. 4(C)) to be displayed on the operation display section 26 (Step S121).

To put it more specifically, for example, the CPU 21 extracts table data (element data) of the element to be displayed on the new job generation verification screen, from the job history display table (FIG. 7 and FIG. 8) according to the flag, and creates a new job display data table (not illustrated) in the work area of the RAM 24 using the extracted element data. The element data to be extracted is the element data wherein the flag 1 indicating the selected status is set. Normally, there is a plurality of data items. The CPU 21 arranges the extracted element data items in a predetermined order and registers them in the new job display data table, and allows the new job generation verification screen to be displayed on the operation display section 26, using this new job display data table.

During the display of the new job generation verification screen, the CPU 21 monitors to check whether or not the new job generation canceling operation or execution operation has been performed, namely, whether or not the cancel button or execution button on the job history display screen has been pressed (a loop from Step S122; No and Step S123; No to Step S121).

When the new job generation has been cancelled (Step S122; Yes), the CPU 21 terminates this sub-processing without generating a new job, and goes back to the main processing of FIG. 5 (Return). When new job generation execution operation has been performed (Step S123; Yes), the CPU 21 generates a new job made up of the elements displayed on the new job generation verification screen, terminates this sub-processing, and goes back to the main processing of FIG. 5 (Return). Further, when a new job has been generated, the CPU 21 executes the new job according to the set processing conditions (elements).

As described above, when setting a new job using the job having been set, the multi-functional peripheral 20 allows selection of each element singly in a plurality of jobs displayed on the job history display screens 50A and 50B, and permits the element to be selected from two or more jobs in a plurality of jobs so that the element is used as a component element of a new job. To be more specific, each element in a plurality of jobs whose history is displayed can be selected cross-sectionally from among a plurality of jobs so that the element is used as a component element of a new job. This procedure provides easy setting of the new job that is composed of a great number of elements due to the expanded scope for element selection, whereby the new job setting convenience is enhanced. Further, in the job history display of the number-of-elements-based display mode, a display priority is given to the jobs having a greater number of elements. This permits selection of a greater number of types of elements.

Further, some of the job elements have different functions according to the job type (major mode) even among the elements having the same or similar designations, as exemplified by the [duplex] of the copy job (duplex printing) and the [duplex] of the scan job (duplex read-in). Thus, for example, when a user wishes to add an element having a desired function to the new job currently being set, if the past job different from the new job contains an element having the same or similar designation as that of the desired element, that element may be selected because it is assumed to perform a desired function in the new job, in some cases.

By contrast, the multi-functional peripheral 20 of the present embodiment converts the selected element according to a predetermined rule if the type of the job at the source of selection of the selected element is different from that of the new job currently being set. Thus, even if the element having the same or similar designation as that of the element desired by the user has been selected from among the past jobs having the type different from that of the new job, this arrangement allows the selected element to be added to the new job after this element has been converted to function in the new job. As described above, the element can be selected from among the past jobs having the type different from that of the new job, and this arrangement enhances the new job setting convenience.

Further, the multi-functional peripheral 20 has a user authentication function. When the user has been authenticated, the jobs having been set and executed by the authenticated user are extracted and their history is displayed. Particular idiosyncrasies often appear for each user in the job settings. Accordingly, extraction of past jobs for each user and display of their history provide the past job setting function of greater utility value for the user on a priority basis.

### Embodiment 2

The following describes the second embodiment of the present invention. The second embodiment includes:

a job mode based display mode wherein the multi-functional peripheral 20 described with reference to the first embodiment has a function of displaying the jobs according to the major mode in the job history display; and

a job element priority display mode wherein display priority is given to the job containing the first selected element—namely, the job containing the selected element itself and the job containing the element of the same type as that of the selected element.

Similarly to the case of the first embodiment, these display modes can be switched by setting (initial setting) of the dip switch or by pressing the display mode switching key. The element of the job displayed on the job history display screen can be selected independently. Further, setting by the dip switch can be achieved in the execution order based display mode, number-of-elements-based display mode or job element priority display mode, or a combination of these modes.

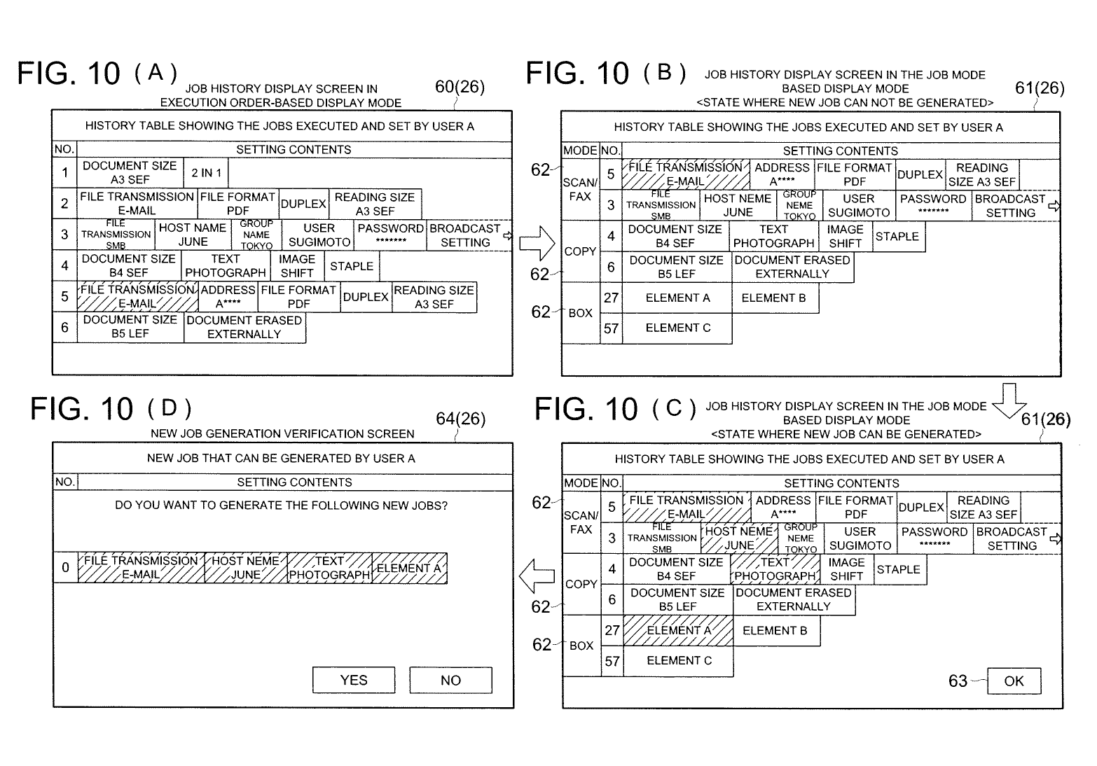

FIG. 10 shows the shift of the screen when a new mode is generated in the job mode based display mode. When the job history display screen 60 in the execution order based display mode shown in FIG. 10(A) or the job history display screen in the number-of-elements-based display mode (not illustrated) is displayed on the operation display section 26 of the multi-functional peripheral 20, if the first element is selected (hereinafter referred to as “the first selected element” in some cases), the CPU 21 changes the flag of the first selected element in the job history display data table (FIG. 7 and FIG. 8) from 0 to 1. If there is an element of the same type as that of the first selected element, the CPU 21 changes the flag of the element of the same type from 0 to 2, and rearranges the jobs.

Rearrangement in the job mode based display mode allows the job containing the first selected element to be placed at the top position of the job history display data table, and classifies all the jobs by major mode based on the major mode data. Further, in the same major mode, the jobs are sequentially arranged in descending order of the number of the elements from top to bottom. If there is a plurality of jobs having the same number of elements, the newer jobs in order of execution are placed at the higher positions, similarly to the case of the number-of-elements-based display mode.

The CPU 21 uses the aforementioned job history display data table to switch the display to the job history display screen 61 in the job mode based display mode shown in FIG. 10(B). This job mode based display mode is automatically selected and is displayed when the first element is selected, if the job mode based display mode has been initially set by dip switch. Even when the job mode based display mode is not initially set by the dip switch, after the first element has been selected in the execution order based display mode or number-of-elements-based display mode, the job mode based display mode is automatically selected and displayed by pressing the display mode switching key.

On the job history display screen 61 of the job mode based display mode, the jobs having been set and executed are classified by major mode and are displayed in a tabulated list. At the same time, the job containing the first selected element (the first selected element per se) is displayed in the top position. As described with reference to the first embodiment, the major modes displayed on the job history display screen 61 include the copy mode to be initially set or set by the user, scan-to-file transmission mode, facsimile mode, and box mode. To put it more specifically, as shown in FIG. 10(B), the job history display screen 61 is provided with the mode column 62 for each major mode, and each mode column 62 indicates the major mode name as exemplified by “Scan/Fax”, “COPY”, or “BOX” as described in the drawing. The jobs in the major mode to be displayed are classified according to the display format correspondence of each mode column 62, and are displayed in a tabulated list. Further, in this example, the first selected element corresponds to the [file transmission E-mail] of job 5. In this case, job 5 is displayed at the top position, and the designation (Scan/Fax) of the major mode of the [file transmission E-mail] is shown in the mode column 62 at the top position.

In the same major mode, jobs are displayed in descending order of the number of elements. If there are a plurality of jobs having the same number of elements, the newer jobs in order of execution are displayed at the higher positions (on a priority basis), similarly to the case of the number-of-elements-based display mode.

In the job history display of the job mode based display mode, job selection and display sequence replacement control (sorting) can be performed to ensure that the number of major modes (types of the jobs) to be displayed will be the maximum.

The job element selection operation method in the job mode based display mode; the display mode of the element in the selection/non-selected status; display control; element conversion control for ensuring that the elements of the past jobs of the different types (different major modes) can be used for a new job; evaluation on the possibility of new job generation; and display/non-display switching control of the OK button in response to the result of the decision are the same as those described with reference to the first embodiment. For example, assuming that job element selection is performed on the job history display screen 61 of FIG. 10(B), and a new job can be generated, then, as shown in FIG. 10(C), the OK button 63 appears on the job history display screen 61. In the case of this example, the [file transmission E-mail] (the first selected element) of job 5 that has been selected as the first element and classified into the “Scan/Fax” mode, and is now displayed on the top position, the [host name: June] of job 3 classified in the same mode, the [text photograph] of job 4 classified in the “COPY” mode, and the [element A] of job 27 classified into the “BOX” mode are in the selected status. A new job can be generated by these elements.

When the OK button 63 of the job history display screen 61 has been pressed, the display screen of the operation display section 26 is switched over to the new job generation verification screen 64 of FIG. 10(D), similarly to the case of the first embodiment. The new job made up of the elements selected on the job history display screen 61 can be generated.

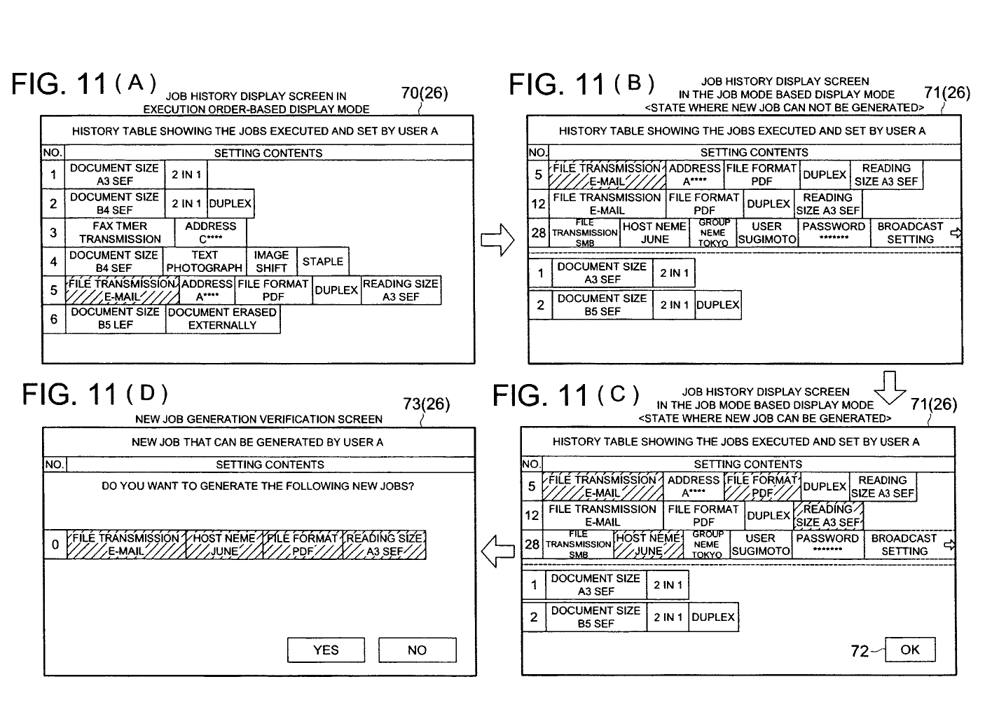

FIG. 11 shows the shift of the screen when the job element priority display mode is used to generate a new job. When, for example, the job history display screen 70 of the execution order based display mode of FIG. 11(A) or the job history display screen of the number-of-elements-based display mode (not illustrated) is displayed on the operation display section 26 of the multi-functional peripheral 20, the first element (the first selection element) is selected. Then the CPU 21 changes the flag of the first selection element in the job history display data table (FIG. 7 and FIG. 8) from 0 to 1. If there is any element of the same type as the first selection element, the CPU 21 changes the flag of the element of the same type from 0 to 2, whereby jobs are rearranged.

To perform rearrangement in the job element priority display mode, the job including the first selected element is placed at the top position in the job history display data table; the jobs including the element of the same type as the first selected element are placed in the second and later positions; and the remaining jobs—jobs that do not include the element of the same type as the first selected element—are placed below these positions. The order of arrangement in the second and later positions conforms to the order in the execution order based or number-of-elements-based display mode, before the job element priority display mode is selected.

To be more specific, when the execution order based display mode has been switched over to the job element priority display mode, the jobs containing the element of the same type as the first selected element are sequentially arranged downward in order of execution in the second and later positions, starting from the newest jobs. The remaining jobs are sequentially arranged below the aforementioned positions downward in order of execution, starting from the newest jobs in the similar manner. When the number-of-elements-based display mode has been changed over to the job element priority display mode, the jobs having the same elements of the same type as the first selection element are sequentially arranged downward in the second and later positions, starting from the job having the greatest number of elements. Similarly, the remaining jobs are sequentially arranged below the aforementioned positions downward, starting from the job containing the greatest number of elements. In the presence of a plurality of jobs having the same number of elements, the newer jobs in order of execution are placed at the higher positions.

Using the aforementioned job history display data table, the CPU 21 switches the display over to the job history display screen 71 in the job element priority display mode of FIG. 11(B). When the job element priority display mode is initially set by the dip switch, this job element priority display mode is displayed by automatic switching when the first element selection operation has been performed. Further, even when the job element priority display mode is not initially set by the dip switch, this mode can be switched and displayed through manual operation by pressing the display mode switching key, after the first element has been selected in the execution order based display mode or number-of-elements-based display mode.

The job containing the first selected element (the first selected element per se) out of the jobs having been set and executed is displayed in the top position on the job history display screen 71 of the job element priority display mode. The jobs containing the element of the same type as the first selected element are displayed in a tabulated list on a priority basis in the second and later positions. In this example, the first selected element is the [file transmission E-mail] of job 5. In this case, as shown in FIG. 11(B), job 5 containing the selected [file transmission E-mail] per se is displayed in the top position on the job history display screen 71. The job containing the “file transmission” of the same type as the [file transmission E-mail] is displayed in a tabulated list on a priority basis in the second and later positions.

When the execution order based display mode (FIG. 11(A)) has been switched over to the job element priority display mode, the jobs of priority display are sequentially displayed, starting from the newest one in order of execution, even in the job element priority display mode (FIG. 11(B). When the number-of-elements-based display mode has been changed to the job element priority display mode, priority display jobs are sequentially displayed starting from the one having the greatest number of elements, even in the job element priority display mode. Further, when the number of priority display jobs in the job element priority display mode is smaller than the number of the jobs that can be displayed on the job history display screen 71, and jobs other than priority display jobs can be displayed, the jobs other than the priority display jobs are displayed below the priority display jobs. In this case as well, when the mode is switched from the execution order based display mode, jobs other than priority display jobs are sequentially displayed starting from the newest one in order of execution. When the mode is switched from the job element priority display mode, jobs other than priority display jobs are sequentially displayed starting from the one containing the greatest number of elements.

In the job history display of the job element priority display mode, except for the jobs containing the first selected element, the selection of the job to be displayed and display sequence replacement control (sorting) are performed according to the display mode conditions (in order of execution or in order of the number of elements) prior to switching.

The job element selection operation method in the job element priority display mode, the mode and control of displaying the elements in selection/non-selected status, the element conversion control wherein the past jobs having the elements of the different types (different major mode) are converted for use in a new job, and the OK button display/non-display switching control conforming to the result of the decision as to the possibility of generating a new job are the same as those of the first embodiment. For example, job element selection is performed on the job history display screen 71 of FIG. 11(B) so that a new job can be generated. Then the OK button 72 appears on the job history display screen 71 as shown in FIG. 11(C). In this example, the [file transmission E-mail] (the first selected element) of job 5 having been selected as the first one and displayed at the top position, the [file format PDF] of the same job 5, the [read-in size A3 Sef] of job 12 containing the element ([file transmission E-mail]) of the same type as the first selected element and the [host name: June] of job 28 containing the element ([file transmission SMB]) of the same type as the first selected element are in the selection status. A new job can be generated by these elements.

When the OK button 72 of the job history display screen 71 has been pressed, the display screen of the operation display section 26 is switched over to the new job generation verification screen 73 of FIG. 11(D), similarly to the case of the first embodiment. Then a new job made up of the elements selected on the job history display screen 71 can be generated.

Referring to a flow chart, the following describes the job history display in the job mode based display mode and job element priority display mode of the present invention and processing of new job generation. Except for the history display and element selection processing described with reference to the first embodiment, processing in each display mode in the present embodiment is the same as that in the first embodiment. To be more specific, the main processing of FIG. 5 and the sub-processing of new job generation of FIG. 9 in the first embodiment are the same as in the second embodiment. There are differences only in the sub-processing of history display and element selection shown in FIG. 6. Thus, the description of the same processing as that of the first embodiment will be omitted. The following describes only the history display and element selection processing different from that of the first embodiment. The following description assumes that the job mode based display mode or job element priority display mode is initially set by the dip switch.

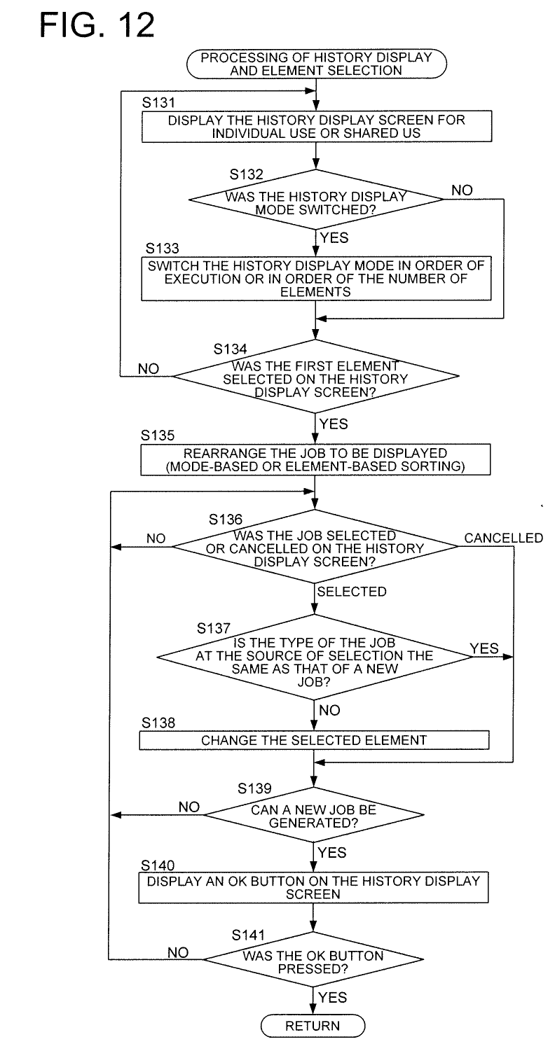

FIG. 12 shows the sub-processing (Step S106 of FIG. 5) of history display and element selection of the present embodiment. Similarly to the case of the first embodiment, when this sub-processing has started, the CPU 21 acquires the table data of history display for individual use or for shared use from the job history table (FIG. 3), and uses this table data to create a job history display data table (FIG. 7 and FIG. 8) in the work area of the RAM 24. Using the job history display data table, the CPU 21 allows the job history display screen for individual use or shared use (FIG. 10(A) and FIG. 11(A)) to be displayed on the operation display section 26 in the execution order based mode or number-of-elements-based display mode set by the dip switch (Step S131). Further, when the display mode has been switched after the job history display screen has been displayed (Step S132; Yes), the CPU 21 switches the job history display screen from the currently selected execution order based or number-of-elements-based display mode to another display mode (Step S133).

During the display on the job history display screen of the execution order-based or number-of-elements-based display mode, the CPU 21 checks if the first element has been selected or not on the job history display screen (S134; No, to a loop of Step S131). When the first element has been selected (Step S134; Yes), the CPU 21 rearranges the jobs (sorting) in the aforementioned job history display data table according to the job mode based display mode or job element priority display mode set by the dip switch. Using the job history display data table, the CPU 21 switches the display screen of the operation display section 26 over to the job history display screen in the job mode based display mode or job element priority display mode (Step S135).

Further, the CPU 21 checks if other elements have been selected or if the selection has been cancelled on the job history display screen of the job mode based display mode/job element priority display mode (Step S136; No, to a loop of Step S136). If other elements have been selected (Step S136; Selected), the CPU 21 determines whether or not the job type (major mode) at the source of selection of that element is the same as the currently set type (major mode) of the new job (Step S137).

When there is difference in type (Step S137; No), the CPU 12 changes the selected element into one that can be used for a new job (Step S138), and goes to the next Step S139. When the selection of the element has been cancelled (Step S136; Canceled), and when the type of job at the source of selection of the selected element is the same as that of the currently set new job (Step S137; Yes), the CPU 12 goes to Step S139.

In Step S139, the CPU 21 determines if a new job can be generated by the currently selected element. If it has been determined that a new job cannot be generated (Step S139; No), the CPU 21 goes back to Step S136. The CPU 21 continues to check whether or not the element of the job displayed on the job history display screen in the job mode based display mode/job element priority display mode has been selected or if the selection has been cancelled. When it has been determined that a new job can be generated (Step S139; Yes), the CPU 21 allows the OK button to be displayed on the job history display screen of the job mode-based display mode/job element priority display mode (Step S140).

If the element in the non-selected status is additionally selected or the selection of the element in the selected status is cancelled (Step S141; No through Step S136; Selected/Cancelled) without the OK button being pressed, the CPU 21 executes Step S136 and thereafter again. If the OK button is pressed (Step S141; Yes), the CPU 21 terminates this sub-processing (history display/element selection processing) and goes back to the main processing of FIG. 5 (Return).

As described above, in the job history display of the job mode based display mode, jobs are displayed in the form classified by major mode. Thus, even if the frequency of use is high in a specific mode such as the copy mode, the jobs in a greater number of modes, namely, a greater number of types of jobs can be displayed without being restricted to the specific mode. This arrangement ensures various forms of elements to be selected from among a great number of jobs, with the result that the scope of selecting different types of elements is expanded. This arrangement thus permits easy setting of a new job made of a great number of types of elements.

In the job history display of the job element priority mode, the job containing the first selected elements (the first selected element and the same type of elements) are displayed on a priority basis. The jobs of the elements that can be selected for the new job to be set by the user and the elements closely related therewith—i.e., the jobs containing a great number of useful elements—tend to be displayed in greater numbers. As described above, the elements suitable for a desired new job are displayed in greater numbers, whereby easy selection and setting of the elements for a desired new job are ensured.

The embodiments of the present invention have been described with reference to the drawings. It should be noted, however, that the specific structures are not restricted to those described with reference to the embodiments. The present invention can be embodied in a great number of variations with appropriate modifications or additions, without departing from the technological spirit and scope of the present invention.

For example, in the multi-functional peripheral 20 of the embodiments, the touch panel type operation display section 26 performs both the operation function and display function. However, the operation function and display function can be separately structured.

In the first embodiment, the multi-functional peripheral 20 is provided with an execution order based display mode and number-of-elements-based display mode, as the display modes for job history display. In the second embodiment, the multi-functional peripheral 20 is further provided with a job mode based display mode and job element priority display mode. However, this does not restrict the possible combinations of display modes incorporated in the multi-functional peripheral 20. The multi-functional peripheral 20 can be provided with any one or more of the number-of-elements-based display mode, job mode based display mode, and job element priority display mode, in addition to the execution order based display mode.

In the job mode based display mode, the jobs having a great number of elements are displayed on the job history display screen for each major mode on a priority basis. It is also possible to arrange such a configuration that the jobs to be displayed are extracted and displayed in conformity to the number of the elements, for example, in such a way that the job having “N” or more elements is displayed. The major mode of the job mode based display mode is classified as the copy mode, scan-to-file transmission mode/facsimile mode and box mode as exemplified in the embodiments, but can be classified differently.

To ensure that the jobs whose histories are displayed on one screen are classified for each predetermined type and are displayed on the operation display section 26, jobs are displayed after being classified for each major mode in the aforementioned embodiments. However, these jobs need not necessarily be classified for each major mode. For example, jobs can be classified into the jobs (of the copy mode or the like) of the printing system using the printing section 30, and the jobs (of the scan-to-file transmission mode, fax mode, box mode) of the non-printing systems that do not use the printing section 30. Alternatively, the jobs can be classified into the jobs (of the scan-to-file transmission mode, fax mode, or the like) of the communication system using the communication section 27, and the jobs (of the copy mode, box mode, or the like) of the non-communication systems that do not use the communication section 27.

In the job element priority display mode, jobs other than priority display jobs (that do not include the same type of element as the first selected element) can also be displayed on the job history display screen. However, it is also possible to arrange such a configuration that only the priority display jobs (the jobs including the first selected element and the jobs containing the same type of element as the first selected element) are displayed. The element that can be selected as the first one in the job element priority display mode is not restricted to the mode element ([file transmission *****]) of the scan-to-file transmission job exemplified in the second embodiment. Any element can be selected as the first one.

It is also possible to provide a display mode wherein the job element priority display mode is combined with the job mode based display mode, as exemplified by the display mode such as the mode element priority display mode. In this display mode, the element that can be selected as the first one is restricted to the mode element alone, without the parameter element or the like (elements other than the mode element cannot be selected as the first element). This arrangement allows the job including the first selected mode element to be displayed on a priority basis, whereby the history of the job with priority given to the mode element is displayed. In this case, the first element of claim 5 is the mode element.

In the job element priority display mode, when a parameter element has been selected as the first element, the job containing that parameter element is displayed on a priority basis. If a parameter element of less frequent use has been selected, the number of the jobs to be displayed may be reduced. In this case, if the first element is a parameter element, the job of the same mode as that of the job containing the parameter element can be added to the job to be displayed on a priority basis. When this arrangement is adopted, even when the parameter element of less frequent use has been selected, the job closely related with the parameter element (the job of the same mode as that of the job including the selected parameter element) can be displayed. The elements suited for a desired new job are displayed in a greater number, whereby the scope of selecting the element is expanded.

In the embodiments, the job type (major mode) at the source of selection of the selected element is different from the type (major mode) of the new job, the selected element is converted according to a predetermined rule. This element conversion process can be applied to all the elements having been selected as the second and later elements, without giving consideration to the job type.

In this case, when the second and later elements have been selected, this element and the major mode of the currently set job are inputted into the element conversion table 41. The element conversion table 41 should register, as a conversion rule (input/output association table, etc.), the element to be outputted in the form associated with all combinations between the element to be inputted, and the major mode of the job. For example, when the input parameter including the selected element and the major mode of the currently set job are the [duplex] and [copy mode] of the copy job, the element conversion table 41 outputs the [duplex] of the copy job. When the input parameter is the [duplex] and [scan mode] of the scan job, the element conversion table 41 outputs the [duplex] of the scan job. When the input parameter includes the [duplex] of the copy job and [scan mode], the element conversion table 41 outputs the [duplex] of the scan job. If the input parameter includes the [duplex] and [copy mode] of the scan job, the element conversion table 41 outputs the [duplex] of the copy job, and so on. The output elements corresponding to all of the patterns of the input parameters should be registered in the element conversion table 41.

In the aforementioned embodiments, job elements are displayed in units of job. For example, a plurality of elements constituting one job can be separately displayed, or can be display after being classified for each element type in such a way that the elements are displayed in units of other than job. In the separate display and element type classified display, it is also possible to display the element by adding to each element the job identification information (execution order based number or name of the job) for identification of the job as the source of element constitution. Further, in the job unit-based display or the display based on something other than the job unit, when the aforementioned job identification information is added to each element to display the element, it is possible to verify what kind of other elements were included when the job containing a specific element was set. This arrangement allows easy identification of the example (previous example) of combining the elements in the job containing a specific element. Even when a plurality of jobs are to be displayed in units of job or in units of something other than the job, the present invention can be applied if at least the element aN of job A made up of a plurality of elements a (element a1, element a2, element a3 . . . ), and the element bN of job B made up of a plurality of elements b (element b1, element b2, element b3 . . . ) can be selected, and a new job composed of the selected elements can be generated.

In this embodiment, the elements of the jobs having been set can be displayed for a plurality of jobs, and the elements selected from among two or more jobs can be reflected on a new job. In addition, this arrangement provides an efficient setting for a new job composed of a great number of elements, whereby new job setting convenience is enhanced.

What is claimed is:

1. An image processing apparatus comprising:
an operation section which accepts a job setting operation;
a memory section which memorizes an element of a job set through the operation section;
a display section, and
a controller,
wherein the controller is configured to control the display section to display a plurality of jobs so as to display elements memorized in the memory section of the plurality of jobs on the display section, accept selecting elements from two or more jobs of the plurality of jobs through the operation section, and generate a new job including the elements selected.

2. The image processing apparatus of claim 1,
wherein the memory section memorizes elements of the jobs in job unit basis, and the controller is configured to control the display section to display the elements of the plurality of jobs in job unit basis on the display section.

3. The image processing apparatus of claim 1,
wherein the controller is configured to control the display section to display jobs having a greater number of elements on a priority basis.

4. The image processing apparatus of claim 2,
wherein the controller is configured to control the display section to display jobs being classified by predetermined types.

5. The image processing apparatus of claim 4,
wherein, while displaying the jobs being classified by predetermined types, the controller is configured to control the display section to selectively display the jobs having a greater number of elements on a priority basis or the jobs being classified by the predetermined types.

6. The image processing apparatus of claim 2,
wherein, when selecting a first element through the operation section is accepted while displaying the elements of the jobs on the display section, the controller is configured to change a priority of the jobs to be displayed on the display section and control the display section to display the jobs containing the element selected for the first element on a priority basis.

7. The image processing apparatus of claim 1,
wherein the controller comprises a judging section for judging if generating the new job becomes enabled by the elements selected and is configured to control the display section to display a job generation executing key in case when the judging section judges that generating the new job is enabled.

8. The image processing apparatus of claim 1,
wherein, in case when a job type of a selection source of an element selected is different from a type of the new job, the element selected is converted according to a predetermined rule.

9. A computer readable media storing a program to make an image processing apparatus comprising an operation section, a memory section, and a display section, execute a method comprising:
accepting a setting operation of a job through the operation section;
memorizing an element of the job set through the operation section in the memory section;
displaying a plurality of jobs so as to display elements memorized in the memory section of the plurality of jobs on the display section;
accepting selecting elements from two or more jobs of the plurality of jobs through the operation section; and
generating a new job including the elements selected.

10. The computer readable media storing the program of claim 9,
wherein the memorizing comprises memorizing elements of the jobs in job unit basis in the memory section and the displaying comprises displaying the elements of the plurality of jobs in job unit basis on the display section.

11. The computer readable media storing the program of claim 10,
wherein the displaying further comprises displaying jobs having a greater number of elements on a priority basis on the display section.

12. The computer readable media storing the program of claim 10,
wherein the displaying further comprises displaying jobs being classified by predetermined types on the display section.

13. The computer readable media storing the program of claim 12,
wherein, while displaying the jobs being classified by predetermined types, the displaying further comprising selectively displaying jobs having a greater number of elements on a priority basis on the display section or displaying the jobs being classified by predetermined types on the display section.

14. The computer readable media storing the program of claim 10,
wherein the accepting further comprises accepting selecting a first element through the operation section while displaying the elements of the jobs on the display section,
the method further comprises changing a priority of jobs to be displayed on the display section when selecting the first element through the operation section is accepted while displaying the elements of the jobs on the display section, and
the displaying further comprising displaying the jobs containing the element selected for the first element on a priority basis.

15. The computer readable media storing the program of claim 10,
wherein the method further comprises:
judging if generating the new job becomes enabled by the elements selected; and
the displaying further comprising displaying a job generation executing key in case when it is judged that generating the new job is enabled.

16. The computer readable media storing the program of claim 9,
wherein the method further comprises converting an element selected in case when a job type of a selection source of the element selected is different from a job type of the new job.

17. A method for controlling an image processing apparatus comprising an operation section, a memory section, and a display section, the method comprising:
accepting a setting operation of a job through the operation section;
memorizing an element of the job set through the operation section in the memory section;
displaying a plurality of jobs so as to display elements memorized in the memory section of the plurality of jobs on the display section;
accepting selecting elements from two or more jobs of the plurality of jobs through the operation section; and
generating a new job including the elements selected.
